(19) United States
(12) Patent Application Publication
(10) Pub. No.: US 2020/0103174 A1
(43) Pub. Date: Apr. 2, 2020

(54) COMPLIANT HEATING SYSTEM COMPRISING A METALLIC EXPANSION JOINT

(71) Applicant: Fulton Group N.A., Inc.

(72) Inventors: Alexander Thomas Frechette, Mexico, NY (US); Carl Nicholas Nett, Sandisfield, MA (US); James Pettiford, Jamesville, NY (US); Richard James Snyder, Mexico, NY (US); Thomas William Tighe, Pulaski, NY (US); Keith Richard Waltz, Sandy Creek, NY (US)

(21) Appl. No.: 15/746,875

(22) PCT Filed: Jul. 25, 2016
(86) PCT No.: PCT/US2016/043861

§ 371 Date: Jan. 23, 2018

Related U.S. Application Data
(60) Provisional application No. 62/282,038, filed on Jul. 24, 2015.

(51) Int. Cl. F28D 7/16; F28D 21/00

(52) U.S. Cl. CPC F28D 7/16; F02M 26/32; F28D 21/0003

(57) ABSTRACT

A compliant heating system includes a dynamic component including a heat exchanger; a pressure vessel shell encompassing at least a portion of the dynamic component; and a metallic expansion joint that connects the dynamic component and the pressure vessel shell, wherein the metallic expansion joint includes a deformable section comprising a convolution.

### CROSS-REFERENCE TO RELATED APPLICATIONS

This application is a National Stage application of International Patent Application No. PCT/US2016/043861, filed on Jul. 25, 2016, which claims priority to U.S. Provisional Patent Application Ser. No. 62/282,038 filed on Jul. 24, 2015, each of which is incorporated herein in its entirety by reference.

### BACKGROUND

### (1) Field

This application relates to a compliant heating system, methods of manufacture thereof, and method of using the compliant heating system.

### (2) Description of the Related Art

Heating systems can fail due to mechanical stress, which develops from differential thermal expansion of components of the heating system during heating or cooling of the system. The mechanical stress develops because the dynamic components that undergo the thermal expansion are rigidly attached to components that do not undergo the same amount of thermal expansion. The occurrence of mechanical failure is particularly true of fluid heating systems for the production of hydronic (water), steam, and thermal fluid for delivering hot liquid or steam for ambient temperature regulation, hot water consumption, commercial applications, and industrial process applications.

The mechanical stress induced by differential thermal expansion is present both in systems that incorporate a tube- and shell heat exchanger and those that employ alternative heat exchanger designs, including tubeless heat exchangers. Techniques for mitigating the mechanical stress, such as complex floating head assemblies or curves and bends in the heat exchanger tubes, all have drawbacks. For example, complex floating head assemblies located inside the pressure vessel are not readily inspectable, serviceable, or replaceable in the field, and can have frequent maintenance; curves and bends in the heat exchanger tubes add compliance, but are not readily inspectable, serviceable, or replaceable and can increase the manufacturing cost and material failure risk.

Therefore there remains a need for an improved heating system that can reduce or eliminate mechanical stress that arises due to differential thermal expansion.

### SUMMARY

Disclosed herein is a compliant heating system including a metallic expansion joint.

In an embodiment a compliant heating system includes a dynamic component comprising a heat exchanger; a pressure vessel shell encompassing at least a portion of the dynamic component; and a metallic expansion joint that connects the dynamic component and the pressure vessel shell; wherein the metallic expansion joint comprises a convolution.

In another embodiment, a method of manufacturing the compliant heating system includes disposing the dynamic component in the pressure vessel shell; connecting the dynamic component and the pressure vessel shell with a rigid attachment located proximal to a first end of the compliant heating system; and connecting the dynamic component and the pressure vessel shell with the metallic expansion joint located proximal to a second end of the compliant heating system to manufacture the compliant heating system.

In another embodiment, a method of using the compliant heating system includes directing a heating fluid through the heat exchanger to an exhaust gas port; and transferring heat from the heating fluid to a production fluid located in an inner production fluid area.

In yet another embodiment, a method of servicing the compliant heating system includes replacing the metallic expansion joint with a new metallic expansion joint.

The above described and other features are exemplified by the following figures and detailed description.

### BRIEF DESCRIPTION OF THE DRAWINGS

Referring to the figures, which are exemplary embodiments, and wherein the like elements are numbered alike and wherein the dashed line in FIGS. 5A, 6A, and 7A denotes an axial axis:

FIG. 1A is a cross-section view of an embodiment of a heating system wherein the exhaust flue is directed axially out of the base;

FIG. 1B is an expanded view of a portion of FIG. 1A showing attachment points of the heating system;

FIG. 2A is a cross-section view of an embodiment of a heating system wherein the exhaust flue is directed laterally out of the base;

FIG. 2B is an expanded view of a portion of FIG. 2A showing attachment points of the heating system;

FIG. 3A is an illustration of an embodiment of a vertical standing heating system;

FIG. 3B is an illustration of an embodiment of a horizontal standing heating system;

FIG. 4A is a cross-section view of an embodiment of a metallic expansion joint;

FIG. 4B is a cross-section view of an embodiment of a metallic expansion joint;

FIG. 5A is a cross-section view of an embodiment of a compliant heating system having a compliant pressure vessel conduit;

FIG. 5B is a cross-section view of a portion B of FIG. 5A;

FIG. 5C is a perspective cut-away view of an embodiment of the compliant heating system of FIG. 5A;

FIG. 5D is a cross-section view of the compliant heating system shown in FIG. 5A when differential thermal expansion is not present;

FIG. 5E is a cross-section view of the compliant heating system shown in FIG. 5A when differential thermal expansion is present;

FIG. 6A is a cross-section view of an embodiment of a compliant heating system including a U-tube exhaust flue, which is directed laterally out of the base;

FIG. 6B is a perspective cut-away view of a portion of the compliant heating system of FIG. 6A;

FIG. 6C is a cross-section view of the compliant heating system shown in FIG. 6A when differential thermal expansion is not present;

FIG. 6D is cross-section view of the compliant heating system shown in FIG. 6A when differential thermal expansion is present;

FIG. 7A is a cross-section view of an embodiment of a compliant heating system wherein a metallic expansion joint is located on the bottom head of the pressure vessel shell;

FIG. 7B is a cross-section view of region B of FIG. 7A;

FIG. 8A is a cross-section view of an embodiment of a compliant heating system wherein a metallic expansion joint is located on the top head of the pressure vessel shell;

FIG. 8B is a cross-section view of region B of FIG. 8A;

FIG. 8C is a perspective cut-away view of an embodiment of the compliant heating system of FIG. 8A;

FIG. 9A is a cross-section view of an embodiment of a metallic expansion joint;

FIG. 9B is a cross-section view of an embodiment of a metallic expansion joint; and

FIG. 9C is a perspective cut-away view of an embodiment of a metallic expansion joint.

### DETAILED DESCRIPTION

Differential thermal expansion over repeated thermal cycling of a heating system can result in the mechanical failure in regions of high stress concentration. For example, mechanical failure can occur at rigid attachment locations between components that experience different amounts of thermal expansion. The rigid attachment location can be, for example, between a dynamic component of the heating system and the pressure vessel shell. While not wanting to be bound by theory, it is understood that mechanical failure can be initiated by local cracking failure mechanisms. Once the initial cracks are formed, exposed metal within the cracks can undergo oxidation, leading to the formation of additional stresses at the crack tip, ultimately followed by crack propagation and component failure.

Component failure in heating systems can be expensive and difficult to repair in the field. For example, disassembly of the pressure vessel to extract the heat exchanger or furnace elements is time consuming and labor intensive, and reassembly often involves specialized welding or joining techniques. Furthermore, fluid heating systems that incorporate methods for stress relief into the hot structures inside the pressure vessel (e.g., in the heat exchanger, in the combustion system, or in the furnace) are expensive and difficult to service, usually prohibitively so, when the components of these stress relief devices fail.

In order to overcome one or more of these drawbacks, disclosed is an improved compliant heating system. The compliant heating system comprises a metallic expansion joint that allows for the reduction or near elimination of stresses that would otherwise arise at attachment points between components that experience different amounts of thermal expansion. Due to the reduction of stress in the compliant heating system, failure of heat exchanger elements, such as heat exchanger tubes, can also be reduced.

The compliant heating system can be designed to localize a thermally-induced differential motion and mechanical stress specifically to the metallic expansion joint. In the absence of this systems-engineering approach to the design of the structure comprising the metallic expansion joint, the thermally-induced mechanical stress is otherwise distributed through-out the heating system, concentrating the failure risk to weaker elements or joints and rendering the likelihood of failure and the location of the failure unpredictable. The inclusion of the metallic expansion joint protects the expensive, delicate, and hard-to-reach components from mechanical stress-induced failure.

The inventors have surprisingly discovered that the metallic expansion joint can be located on the external pressure vessel shell or on an externally located conduit of the pressure vessel shell, where it is exposed and readily available for service. Since the metallic expansion joint can function to localize the differential motion and mechanical stress to an external location, the expensive, delicate, and hard-to-reach components can be protected from mechanical stress-induced failure with the added benefit that the metallic expansion joint can be easily inspected and serviced. It is noted that the external location refers a location external to the compliant heating system (such as one or both of the external pressure vessel shell or on an externally located conduit of the pressure vessel shell) and that the external location can be enclosed or at least partially enclosed, for example, with a removable cover or shield.

For example, the metallic expansion joint can be externally located on a pressure vessel shell or on an externally located conduit of the pressure vessel shell. An easily accessible metallic expansion joint allows field servicing without the use of specialized equipment or complex joining techniques such as welding. In this manner, the metallic expansion joint can be regularly inspected for wear, cracking, or fatigue to enable problems to be addressed before component failure. This inspection can be performed periodically and can involve visual inspection, and can include a non-destructive inspection for detecting wear, cracking, and material fatigue of the metallic expansion joint to anticipate and address problems before a failure occurs. A service life of the compliant heating system can therefore be improved, and can be 10 to 30 years or longer.

Moreover, the inventors have discovered that the thermal stress relief can be achieved using serviceable components in both the axial and lateral exhaust configurations. In either orientation, thermal stress relief can be incorporated in an external location in an inspectable, removable, replaceable, and serviceable manner; that is, on those components of the production fluid pressure vessel of a fluid heating system that can be exposed for maintenance with little or no disassembly of the compliant heating system.

When the thermally-induced mechanical stress is localized to replaceable, compliant elements on the pressure vessel shell, methods known to those skilled in the art enable incorporation to match or exceed the pressure limits of the production fluid pressure vessel and can satisfy current safety standards for fluid heating system pressure vessels.

A compliant heating system can comprise a shell and tube heat exchanger, where heat from a thermal transfer fluid located in a tube is transferred to a production fluid located in the pressure vessel shell. The thermal transfer fluid can be heated in a furnace, and can be a product of the combustion of a fuel and can optionally include air, steam, or water. The thermal transfer fluid can travel from the furnace through a tube to an exhaust gas plenum, which is located at a distal end of the tube. The tube can comprise a single tube and can be, for example, a coiled tube. The tube can comprise a plurality of heat exchanger tubes. An upper tube sheet can be located between the furnace and the tube and a lower tube sheet can be located at an opposite distal end of the tube and between the tube and the exhaust gas plenum. The pressure vessel shell can be fixedly attached to one or more of the furnace, the upper tube sheet, the lower tube sheet, or the exhaust gas plenum. The heat exchanger (for example, a tube), and optionally one or both of the furnace and the exhaust gas plenum, can be disposed within the pressure vessel shell.

The heat exchanger can exchange heat between the thermal transfer fluid and a production fluid, wherein the production fluid and the thermal transfer fluid can each independently comprise one or both of a gas and a liquid. Thus, the compliant heating system can be used as a gas-liquid, liquid-liquid, or gas-gas heating system. As used herein, the thermal transfer fluid is directed through the heat exchanger and does not contact the pressure vessel or the production fluid; and the production fluid is directed through the pressure vessel and is in contact with the inner surface of the pressure vessel shell and the outer surface of the heat exchanger.

The thermal transfer fluid can comprise a combustion gas, such as a gas produced by fuel fired combustor. The heating fluid can comprise one or more of water, steam, carbon monoxide, and carbon dioxide. The production fluid can comprise one or more of an ester, a diester, a glycol, a silicone, water, steam, an oil (such as petroleum oil and mineral oil), and a chlorofluorocarbon (such as a halogenated fluorocarbon, a halogenated chlorofluorocarbon, and a perfluorocarbon). A production fluid comprising glycol and water is specifically mentioned. The production fluid may comprise an alkaline organic and/or inorganic compound in an amount of 3 to 10 weight percent, based on a total weight of the production fluid.

In an embodiment, the pressure vessel shell does not contact the thermal transfer fluid, which can have a temperature of 50 to 1,800° C., or 100 to 1,350° C., and thus the pressure vessel shell can remain relatively cool as compared to the heat exchanger, for example, which contacts the thermal transfer fluid, and thus the pressure vessel shell can have less thermal expansion than other components, such as the heat exchanger. For example the pressure vessel shell can have a temperature of the production fluid, e.g., 50° C. to 200° C., or 75° C. to 150° C., for example.

The metallic expansion joint can be located on one or both of the pressure vessel shell and a conduit of the pressure vessel shell. The metallic expansion joint can join/connect/be disposed between the pressure vessel shell (or a conduit thereof) and the dynamic component. The conduit of the pressure vessel shell can be directed at an angle of 0 to 180° from the pressure vessel shell relative to an axial axis of the pressure vessel shell. The conduit of the pressure vessel shell can be directed axially out of the base (for example, at an angle of 0°) or can be directed in a lateral direction relative to the axial direction of the pressure vessel shell (for example, at an angle of 90°). The conduit of the pressure vessel shell can comprise a bend. The bend can have be a 0 to 180° bend relative to its axis of departure from the pressure vessel shell. For example, if the conduit is directed axially out of the pressure vessel shell, then the bend can have an angle of 0 to 180° relative to the axial axis and if the conduit is directed laterally out of the pressure vessel shell, then the bend can have an angle of 0 to 180° relative to the lateral axis.

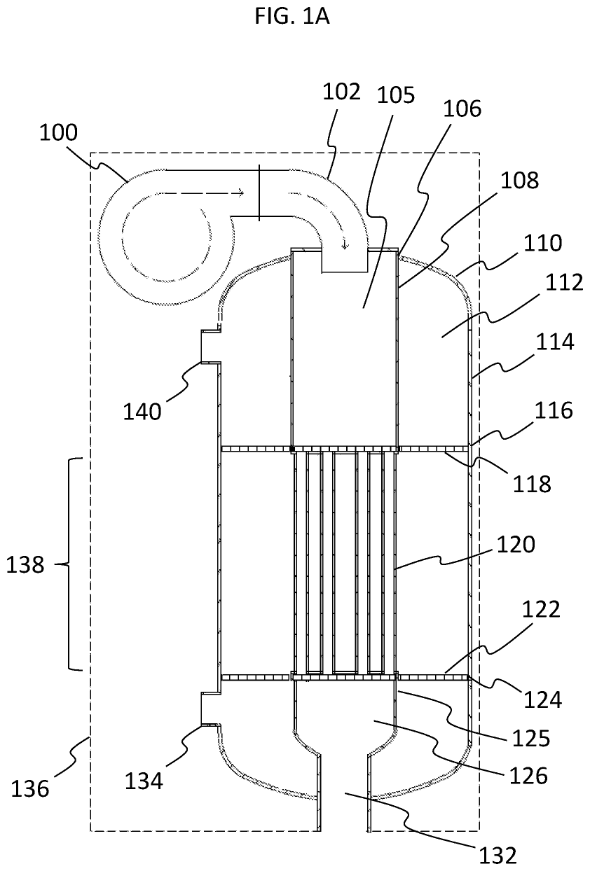

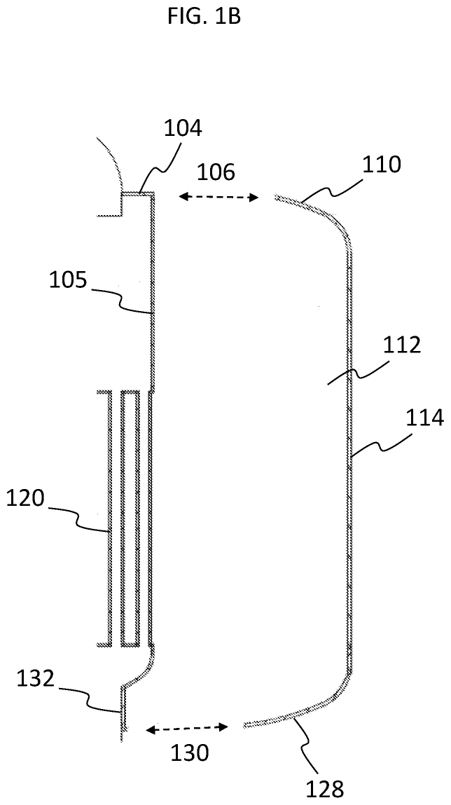

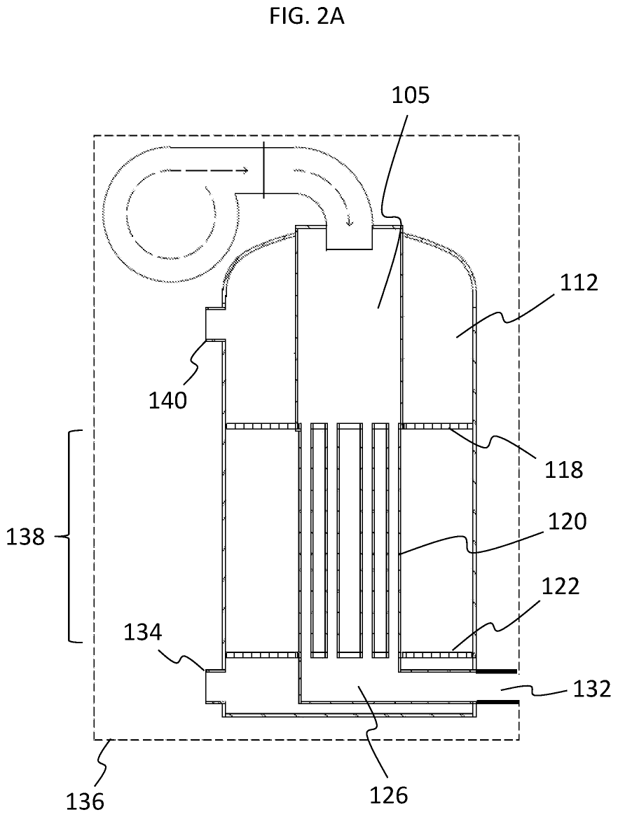

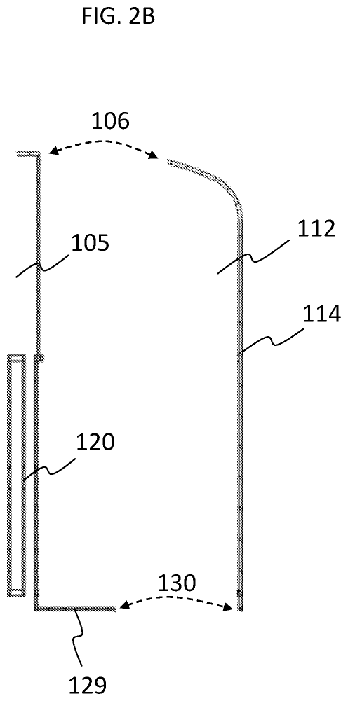

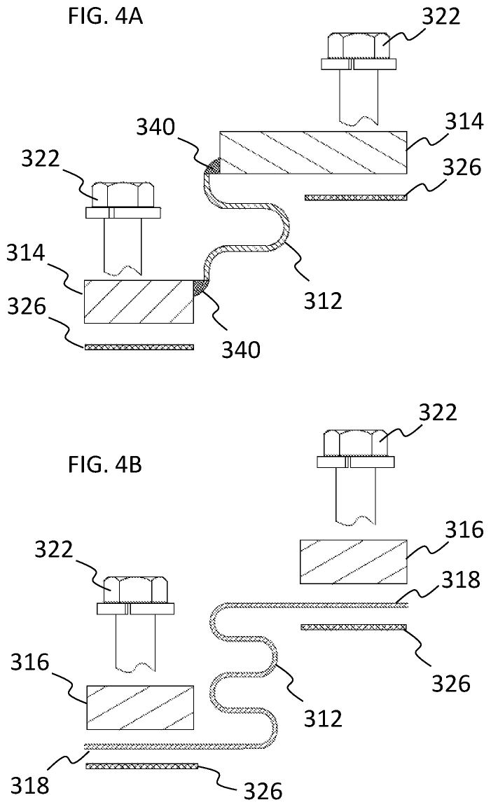

FIG. 1A and FIG. 2A are cross-section views of an embodiment of a heating system in which the exhaust flue is directed axially out of the base and is directed laterally out of the base, respectively. In the figures, fan blower 100 forces air into combustion furnace 105 through conduit 102. When a combustion furnace is present, the combustion furnace can heat and/or generate a thermal transfer fluid (e.g., hot air) and/or combustion products, for example, by gas combustion, oil combustion, petroleum fuel combustion, electric energy conversion, or any combination thereof. In the absence of a combustion furnace, hot gasses can be supplied by any suitable source, for example, exhaust from a high temperature turbine, or high pressure boiler. The thermal transfer fluid travels through heat exchanger section 138 extending from upper tube sheet 118 to lower tube sheet 122 via heat exchanger tubes 120 to exhaust gas plenum 126 and exits via exhaust gas port 132. The production fluid enters the heating system via inlet port 134, traverses heat exchanger section 138, enters inner production fluid area 112, and exits through outlet port 140. It is noted that upper tube sheet 118 and lower tube sheet 122 can be fixedly attached to pressure vessel shell 114, as illustrated in FIG. 1A and FIG. 2A, for example, to improve the structural support of the heating system, or can have a width less than that of pressure vessel shell 114 such as is illustrated in FIG. 4A. When upper tube sheet 118 and lower tube sheet 122 are fixedly attached to pressure vessel shell 114, upper tube sheet 118 and lower tube sheet 122 can allow for the production fluid to pass through the respective sheets. Conversely, one or both of upper tube sheet 118 and lower tube sheet 122 can prevent the through flow of the production fluid.

Pressure vessel shell 114 can be fixedly attached at one or more attachment points, including, but not limited to furnace wall 108 (for example, at furnace head attachment point 106), to a tube sheet (for example, at upper tube sheet attachment point 116 and at lower tube sheet attachment point 124), and to exhaust gas plenum wall 125 (for example, at bottom head attachment point 130). As shown in FIG. 1B, the pressure vessel shell 114 can comprise a pressure vessel shell top head 110, which is fixedly attached to furnace head 104 at furnace head attachment point 106, and a pressure vessel shell bottom head 128, which is fixedly attached at bottom head attachment point 130. As shown in FIG. 2B, the pressure vessel shell 114 can be fixedly attached to furnace head 104 at furnace head attachment point 106 and pressure vessel shell 114 can be fixedly attached to flange 129 at bottom head attachment point 130.

The body cover 136, e.g., a shield, can be removably attached to provide for easy access to the heating system. Alternatively, or in addition, the body cover 136 can comprise one or more removable panels to facilitate access for service and maintenance. When the body cover 136 is removed or opened, one or more of the exterior components of the heating system can be accessed. Examples of exterior components can include, but are not limited to, furnace head 104, pressure vessel shell 114, exhaust gas plenum wall 125, and exhaust gas port 132. Also, because the pressure vessel shell is fixedly attached in proximity to the heat exchanger section, for example, by welding, the interior components, such as the heat exchanger tube and the furnace are inaccessible.

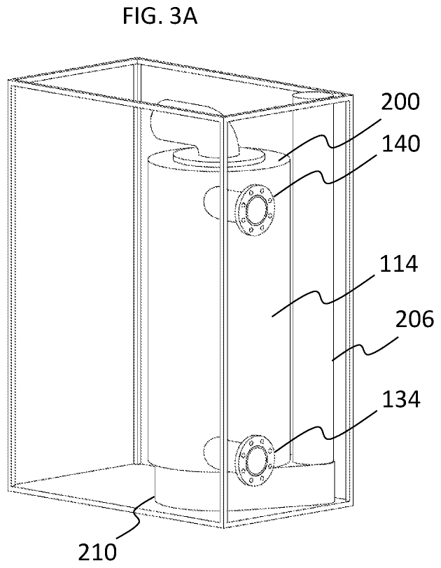

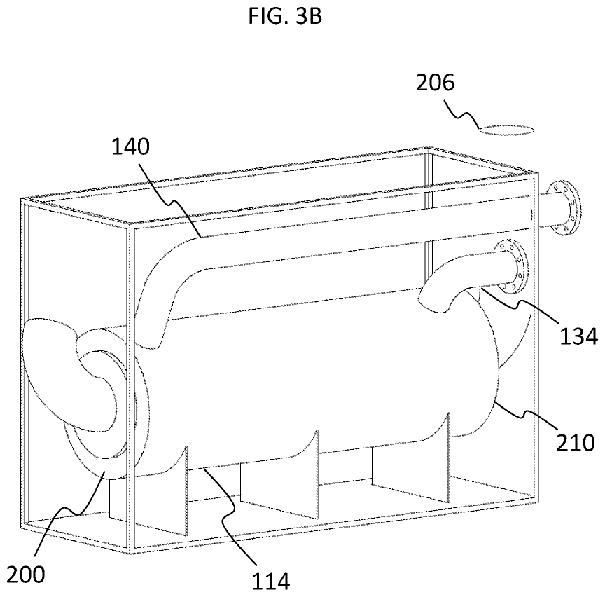

FIG. 3A and FIG. 3B are illustrations of embodiments of a vertical standing heating system and of a horizontal standing heating system, respectively. As shown in FIG. 3A and FIG. 3B, exterior components are accessible when the body cover is removed. Specifically, FIG. 3A and FIG. 3B illustrate that accessible exterior components can comprise top head assembly 200, pressure vessel shell 114, base 210, exhaust flue 206, inlet port 134, and outlet port 140.

When the compliant heating system is quiescent, the furnace and heat exchanger assembly may be at room temperature, e.g., 23 to 25 degrees Celsius (° C.). In operation, the temperature of the furnace and heat exchanger are increased and the metal components expand. The expansion can occur in an axial direction, e.g., in a longitudinal direction along a major axis, for example, along a central axis of the compliant heating system. The components along the path of the heating fluid of the heat exchanger, such as the furnace, the upper tube sheet, the heat exchanger tube, the lower tube sheet, and the exhaust gas plenum can be subjected to high temperatures during the operation of the compliant heating system and can therefore undergo thermal expansion. Conversely, the pressure vessel shell, which is in contact with the production fluid and thus remains at a lower temperature, can undergo little to no thermal expansion during operation. Along the axial direction of the fluid heating system, the expansion of the individual metal components can be additive, resulting in a dimensional expansion in the axial direction of 1.5 millimeters, for example. As is described herein, the metallic expansion joint can be used to alleviate or eliminate stresses that arise due to the differential thermal expansion that occurs during operation of the compliant heating system. These stresses can be alleviated through a reversible deformation of a deformation section of the metallic expansion joint.

The metallic expansion joint can comprise a deformable section having a convolution. The number of convolutions (also referred to herein as the convolution number) can be determined, for example, by dividing a length of the deformable section by a peak to peak spacing distance. FIG. 4A illustrates deformable section 312 having 1 convolution and FIG. 4B illustrates deformable section 312 having 2 convolutions. The convolution number can be 0.5 to 20, or 1 to 10, or 1 to 2. The convolutions can be wave-like, where the deformable section is also referred to as a corrugate structure; or can be zig-zag, where the deformable section is also referred to as a bellows structure. The deformable section can have a thickness of 0.25 to 5 millimeters (mm), or 0.5 to 4 mm, or 0.5 to 10 mm, or 0.2 to 10 mm, or 0.5 to 1 mm.

The deformable section can be attached to the compliant heating system via a metallic flange, e.g., two metallic flanges, that are connected to the ends of the deformable section, for example, as illustrated in FIG. 4A. FIG. 4A illustrates deformable section 312 connected to metallic flanges 314 via weld 340 on both ends of deformable section 312. Metallic flanges 314 can be connected to the compliant heating system via bolts 322. Gaskets 326 can be located in between metallic flanges 314 and the compliant heating system.

The deformable section can be attached to the compliant heating system via a metallic mounting location that can be located on the deformable section and/or on a metallic extender, where the metallic extender refers to a portion of the deformable section that extends past a convolution width. The metallic extender can be a single piece with the deformable section or can be fixedly attached. The metallic extender can have the same or different width as the width of the deformable section. A mounting ring can optionally be used to further stabilize the connection. FIG. 4B illustrates deformable section 312 can comprise two metallic extenders 318 located on both ends of deformable section 312. Metallic extenders 318 can be connected to the compliant heating system via optional mounting rings 316 and bolts 322. Gaskets 326 can be located in between metallic extenders 318 and the compliant heating system.

The gaskets, if present, can function to seal and prevent the internal fluid from leaking out of the metallic expansion joint. The gasket can comprise any suitable material, such as an elastomer. The gasket can comprise one or more of a styrene based elastomer (such as styrene-butadiene-styrene (SBS) block copolymer, a styrene-ethylene-butadiene-styrene (SEBS) block copolymer, a styrene-(styrene butadiene)-styrene block copolymer, a styrene butadiene rubber (SBR), an acrylonitrile-butadiene-styrene copolymer (ABS)), a butadiene rubber (BR), a natural rubber (NR), an isoprene rubber (IR), an ethylene-propylene-diene monomer (EPDM) (for example, a partial or complete hydride thereof), a fluoroelastomer (such those derived from one or more of vinylidene fluoride, hexafluoropropylene, pentafluoropropylene, tetrafluoroethylene, and chlorotrifluoroethylene), and a nitrile material.

The metallic expansion joint can be located on an exterior component of the compliant heating system. The metallic expansion joint can be located on the pressure vessel shell. The pressure vessel shell can comprise a pressure vessel shell conduit, which extends from an end or from a side of the pressure vessel shell, and the metallic expansion joint can be located on the pressure vessel shell conduit. The pressure vessel shell and the dynamic components, such as the furnace, the upper tube sheet, the lower tube sheet, and the exhaust gas plenum, can be attached via the metallic expansion joint and a rigid attachment point, for example, a single rigid attachment point, allowing for differential thermal expansion, e.g., differential thermal expansion of the dynamic components and the pressure vessel shell.

The metallic expansion joint can have a low axial spring constant. While not wanting to be bound by theory, it can be understood that when the metallic expansion joint has a low axial spring constant, for example, a spring constant within the foregoing range, the metallic expansion joint has improved ability to absorb a total differential thermal expansion of the system in an axial direction. In further detail, a spring constant k of the metallic expansion joint can be expressed in terms of the force F used to expand or compress the metallic expansion joint to distance x. Thus the spring constant k of the metallic expansion joint can be expressed as shown in Formula 1:

k=F/x (1).

The metallic expansion joint can have a spring constant of 175 to 44,000 Newtons per millimeter (N/mm), or 350 to 35,000 N/mm, or 450 to 27,000 N/mm. Use of a metallic expansion joint having a spring constant of 350 to 35,000 N/mm is preferred.

The metallic expansion joint can accommodate a total axial deflection of the dynamic components of 0.1 to 10 centimeters (cm), 0.2 to 8 cm, or 0.3 to 7 cm, or 0.4 to 6 cm. An embodiment in which the metallic expansion joint can accommodate a total axial deflection of 0.1 to 5 cm is mentioned.

The metallic expansion can have a squirm pressure of 35 to 1,750 kilopascals (kPa), 70 to 1,380 kPa, or 100 to 1,200 kPa, where the squirm pressure is the pressure at which an in-plane instability of the metallic expansion joint occurs. The metallic expansion can have a squirm pressure of 100 to 1,380 kPa. While not wanting to be bound by theory, it is understood that use of a metallic expansion joint having improved squirm pressure accommodates in-plane forces, which develop from differential thermal expansion.

The metallic expansion joint can contain a pressurized production fluid in the pressure vessel shell. In an embodiment, the metallic expansion joint can contain a production fluid having a pressure of 50 to 1,750 kPa, 100 to 1,400 kPa, or 200 to 1,200 kPa.

The metallic expansion joint can have a fatigue life of 150,000 to 1,000,000 cycles, where 1 cycle is equal to one heating and cooling step of the compliant heating system.

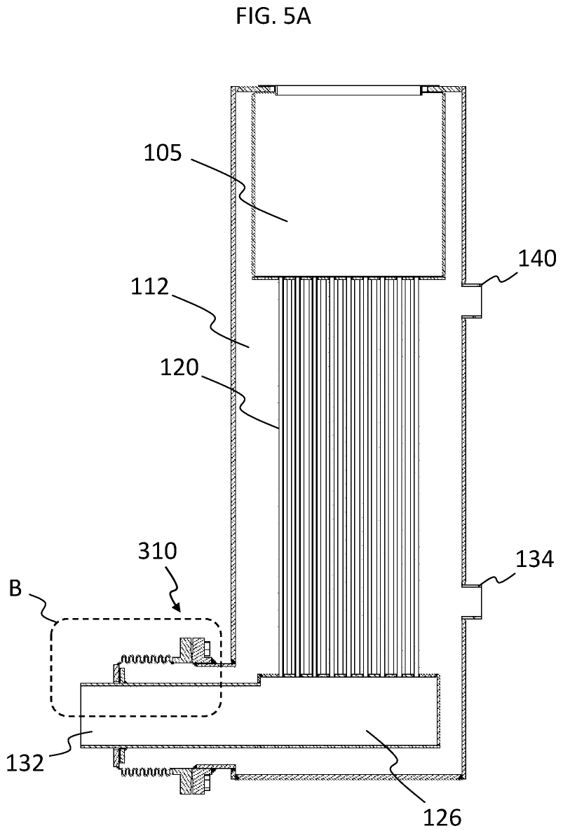

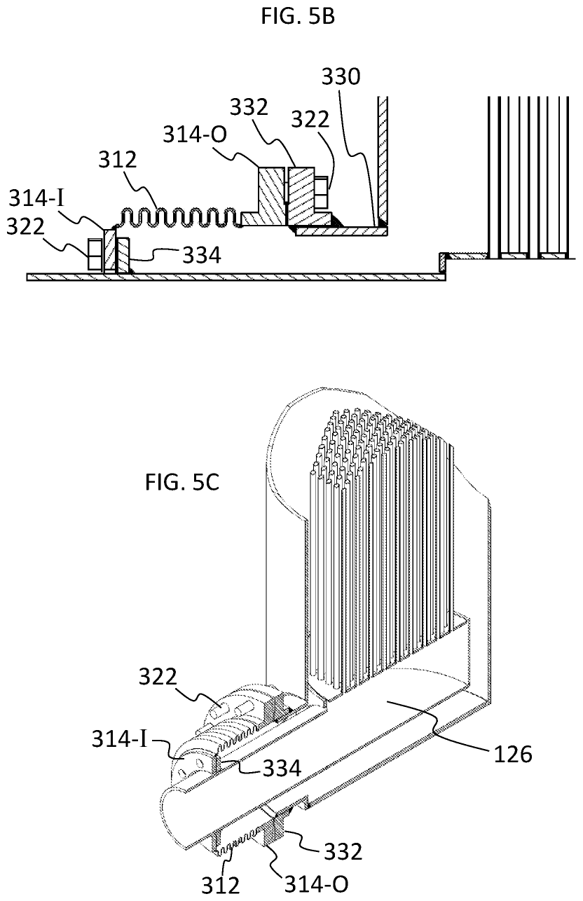

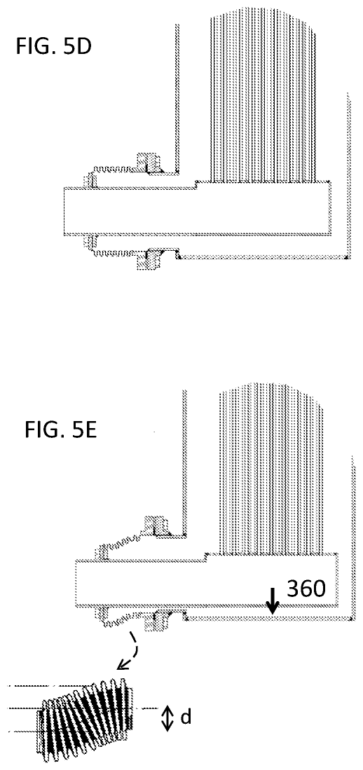

FIGS. 5A to 5E illustrate an embodiment of a compliant heating system having metallic expansion joint 310 located on a pressure vessel shell conduit that is directed laterally out of the base. Due to the lateral directionality of the exhaust flue, the overall length of the compliant heating system can be reduced and can allow for a facilitated ducting of the exhaust gas. When the compliant heating system comprises a deformable section located on a laterally directed pressure vessel shell conduit, the deformable section can comprise greater than 1, or 3 or more, or 3 to 20 convolutions as increasing the number of convolutions can increase the deformable section's ability to translate in the direction perpendicular to its annular axis.

As shown in FIG. 5A, the heating fluid travels from combustion furnace 105 through heat exchanger tubes 120 to exhaust gas plenum 126 and exits via exhaust gas port 132 that is directed axially out of the base. A base of exhaust gas plenum can be pitched towards exhaust gas port 132 to facilitate a condensate in condensing applications. FIG. 5B is an illustration of cut-out section B from FIG. 5A and FIG. 5C is a perspective cut-away of the compliant heating system. The figures illustrate that metallic expansion joint 310 can comprise deformable section 312, inner metallic flange 314-I, and outer metallic flange 314-O. Deformable section 312 can be fixedly attached to inner metallic flange 314-I and outer metallic flange 314-O, for example, via welds.

Outer metallic flange 314-O can be connected to pressure vessel shell 114 via pressure vessel mounting flange 332 located on pressure vessel extension flange 330 that laterally extends out of pressure vessel shell 114 and that can be located around a portion of exhaust gas port 132, for example, as illustrated in FIG. 5A and FIG. 5C. Pressure vessel extension flange 330 can be fixedly attached to pressure vessel shell 114, for example, via a weld. Pressure vessel extension flange 330 can be fixedly attached to pressure vessel mounting flange 332, for example, via a weld. Pressure vessel mounting flange 332 can be connected to outer metallic flange 314-O via threaded bolt 322. A gasket can be located in between pressure vessel mounting flange 332 and outer metallic flange 314-O.

Inner metallic flange 314-I can be connected to exhaust gas port 132 via exhaust conduit flange 334. Exhaust conduit flange 334 can be fixedly attached to exhaust gas port 132, for example, via a weld. Exhaust conduit flange 334 can be connected to inner metallic flange 314-I via threaded bolt 322. A gasket can be located in between exhaust conduit flange 334 and inner metallic flange 314-I.

FIG. 5D and FIG. 5E illustrate an embodiment of how the metallic expansion joint can accommodate the differential thermal expansion of the heating system. FIG. 5D illustrates a cooled state of the compliant heating system and FIG. 5E illustrates a heated state of the compliant heating system undergoing axial expansion 360. Axial expansion 360 of the dynamic components when heated can result in a displacement d of the metallic expansion joint.

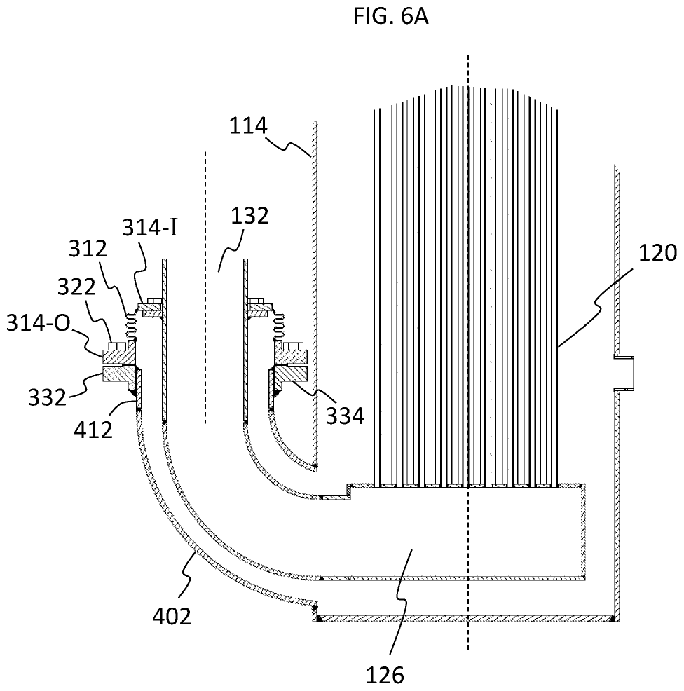

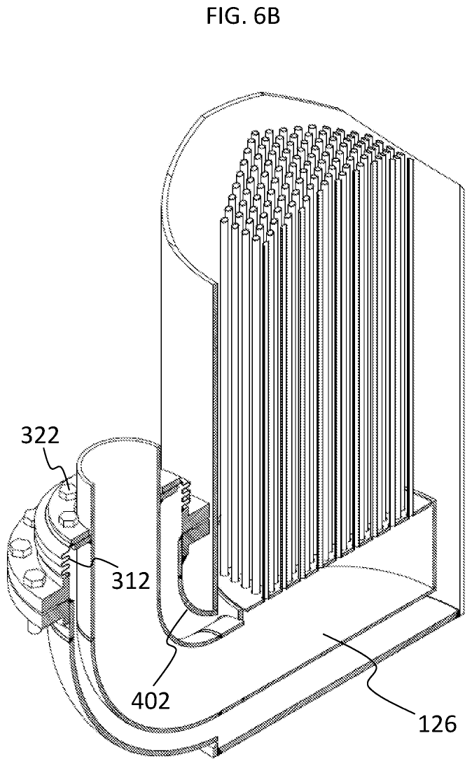

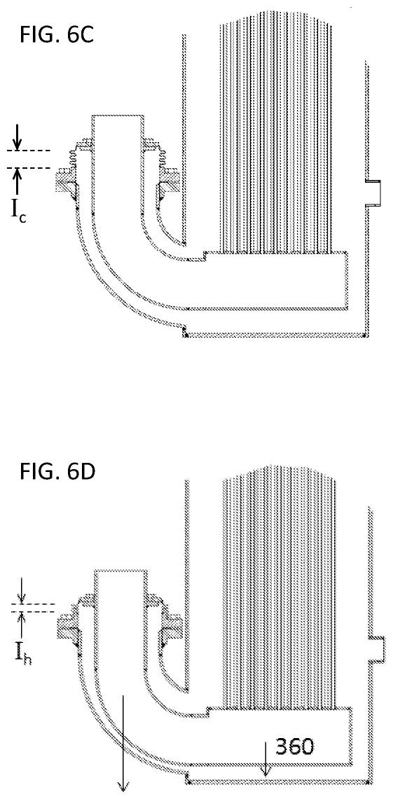

FIGS. 6A to 6D illustrate that the compliant heating system can have a metallic expansion joint 310 located on a U-shaped pressure vessel shell conduit that is directed laterally out of the base. Due to the lateral directionality of the exhaust flue, the overall length of the compliant heating system can be reduced and can allow for a facilitated ducting of the exhaust gas. Due to the U-shape of the pressure vessel shell conduit, the displacement of the metallic expansion joint can be in the axial direction. For example, FIG. 6A illustrates that an annular axis of the metallic expansion joint 310 can be parallel to the axial direction of the of the pressure vessel.

FIG. 6A, illustrates that the thermal transfer fluid can exit via exhaust gas port 132 that comprises the U-tube directed laterally out of the base. The pressure vessel shell 114 can comprise a curved pressure vessel shell conduit 402 that laterally extends out of pressure vessel shell 114 and that can be located around a portion of exhaust gas port 132, for example, as illustrated in FIG. 6A and FIG. 6B. Curved pressure vessel shell conduit 402 can be connected to combustion gas exhaust port 132 via metallic expansion joint 310. Curved pressure vessel shell conduit 402 can optionally comprise pressure vessel extension 412, for example, as is illustrated in FIG. 6A. Outer metallic flange 314-O can be connected to pressure vessel shell 114 via pressure vessel mounting flange 332. Pressure vessel mounting flange 332 can be rigidly connected to curved pressure vessel shell conduit 402, for example, via welds 340. Pressure vessel mounting flange 332 can be connected to outer metallic flange 314-O via bolt 322. A gasket can be located in between pressure vessel mounting flange 332 and outer metallic flange 314-O.

Inner metallic flange 314-I can be connected to exhaust gas port 132 via exhaust conduit flange 334. Exhaust conduit flange 334 can be fixedly attached to exhaust gas port 132, for example, via a weld. Exhaust conduit flange 334 can be connected to inner metallic flange 314-I via threaded bolt 322. A gasket can be located in between exhaust conduit flange 334 and inner metallic flange 314-I.

FIG. 6C and FIG. 6D illustrate how a metallic expansion joint located on a U-tube can accommodate the differential thermal expansion of the heating system. FIG. 6C illustrates a cooled state of the compliant heating system and FIG. 6D illustrates a heated state of the compliant heating system undergoing axial expansion 360. Axial expansion 360 of the dynamic components when heated can result in a decrease in the length of the deformable section from cooled deformable section length l_{c} to heated deformable section length lₕ of metallic expansion joint 310. As illustrated in FIG. 6D, the placement of the metallic expansion joint on the parallel portion of the U-tube relative to the axis of the pressure vessel shell conduit can result in the displacement of the metallic expansion joint in the axial direction. It is noted, that in this configuration, the production fluid exerts a force on an inner surface of the deformable section, oriented outwards from a center of an annulus of the ring formed by the deformable section.

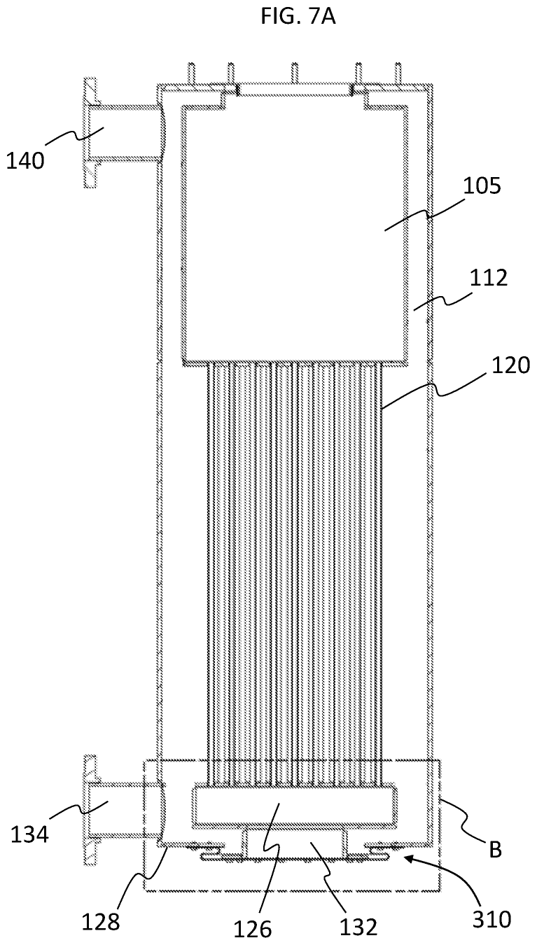

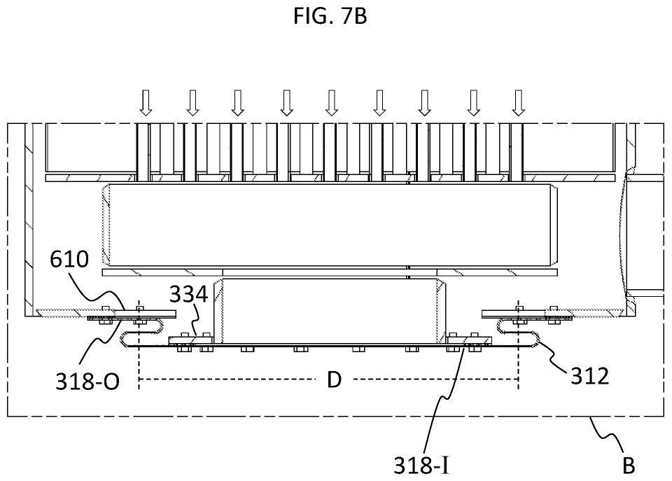

FIGS. 7A and 7B illustrate that the compliant heating system can have a metallic expansion joint located on a bottom head of the pressure vessel shell that can be directed axially out of the base. The metallic expansion joint can have the same diameter as a diameter of the pressure vessel shell or it can have a smaller diameter, where the deformable section diameter can be measured from a midline of the convolutions as illustrated in FIG. 7B. FIGS. 7A to 7B illustrate that the deformable section can have a smaller diameter than the pressure vessel shell. This reduced diameter can allow for a thinner deformable section while maintaining the design pressure specifications of the pressure vessel. It is noted that the metallic expansion joint could likewise be located on a pressure vessel conduit axially directed out of the base of the pressure vessel shell. As shown in FIG. 7A, the thermal transfer fluid travels from combustion furnace 105 through heat exchanger tubes 120 to exhaust gas plenum 126 and exits via exhaust gas port 132 that is directed axially out of the base and where the exhaust gas port 132 is attached to pressure vessel shell bottom head 128 via metallic expansion joint 310.

An expanded view of inset B of FIG. 7A is illustrated in FIG. 7B. FIG. 7B illustrates that deformable section 312 and outer metallic extender 318-O can be connected to bottom head flange 610. Bottom head flange can be part of the pressure vessel shell or can be a separate piece from the pressure vessel shell that is, for example, welded to the pressure vessel shell. Bottom head flange 610 can be connected to one or both of deformable section 312 and outer metallic extender 318-O via one or more threaded bolts 322. A gasket can be located in between bottom head flange 610 and outer metallic extender 318-O.

Inner metallic extender 318-I can be connected to exhaust gas port 132 via exhaust conduit flange 334. Exhaust conduit flange 334 can be fixedly attached to exhaust gas port 132, for example, via a weld. Exhaust conduit flange 334 can be connected to inner metallic extender 318-I via threaded bolt 322. A gasket can be located in between exhaust conduit flange 334 and inner metallic extender 318-I.

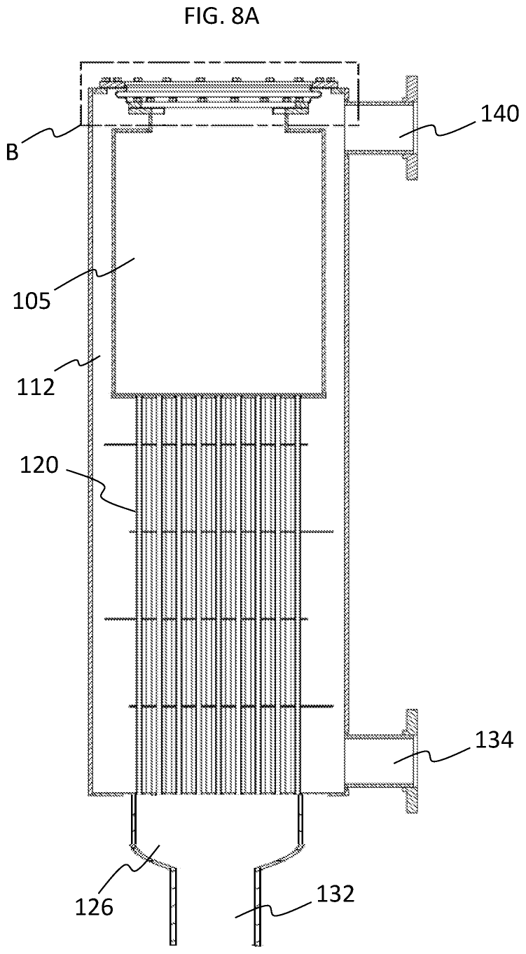

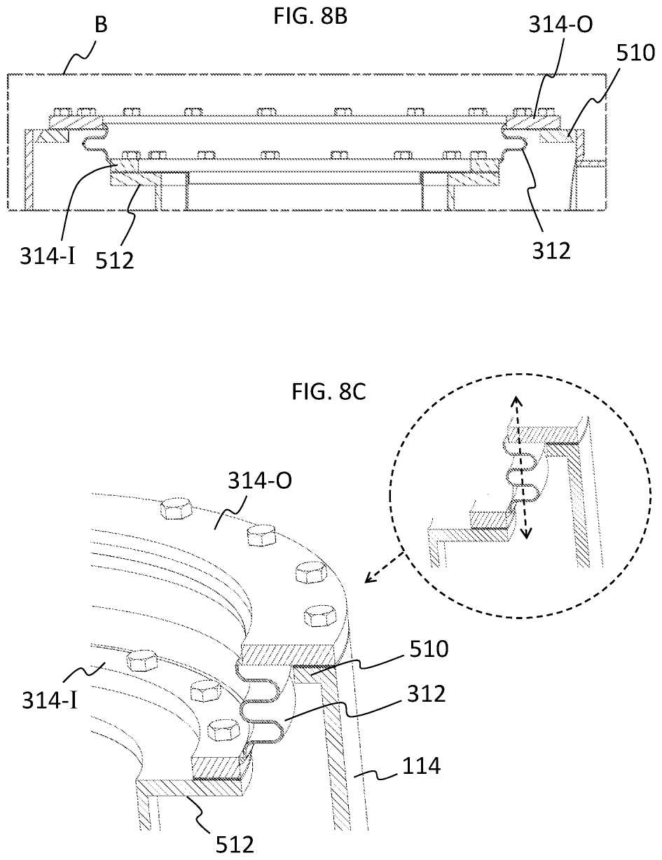

FIGS. 8A to 8C illustrate that the compliant heating system can have a metallic expansion joint located on a top head of the pressure vessel shell that can be directed axially out of the top head assembly. The metallic expansion joint could likewise be located on a pressure vessel conduit axially directed with respect to the top head of the pressure vessel shell. As shown in FIG. 8A, combustion gas flows into combustion furnace 105 in the direction of the arrow, the heating fluid travels from combustion furnace 105 through heat exchanger tubes 120 to exhaust gas plenum 126, and exits via exhaust gas port 132 that is directed axially out of the base; where the top head of the pressure vessel shell is connected to combustion furnace 105 via metallic expansion joint 310.

An expanded view of inset B of FIG. 8A is illustrated in FIG. 8B. FIG. 8B illustrates that metallic expansion joint 310 can comprise deformable section 312, inner metallic flange 314-I, and outer metallic flange 314-O. Deformable section 312 can be fixedly attached to inner metallic flange 314-I and outer metallic flange 314-O, for example, via welds. FIG. 8B illustrates that deformable section 312 can have a single convolution and FIG. 8C illustrates that deformable section 312 can have 2 convolutions. Any suitable number of convolutions can be used, e.g., 2 to 50, or for 4 to 25 convolutions, for example. FIG. 8C further illustrates in the inset the axis of displacement when the compliant heating system is heated. Outer metallic flange 314-O can be connected to pressure vessel shell 114 via top head flange 510. Top head flange 510 can be part of the pressure vessel shell or can be a separate piece from the pressure vessel shell that is, for example, welded to the pressure vessel shell. Top head flange 510 can be connected to outer metallic flange 314-O via threaded bolt 322. A gasket can be located in between top head flange 510 and outer metallic flange 314-O. Inner metallic flange 314-I can be connected to the furnace via furnace flange 512. Furnace flange 512 can be fixedly attached to the furnace, for example, via a weld. Furnace flange 512 can be connected to inner metallic flange 314-I via threaded bolt 322. A gasket can be located in between furnace flange 512 and inner metallic flange 314-I. It is noted, that in this configuration, the production fluid exerts a force on an outer surface of the deformable section, oriented inwards towards a center of an annulus of the ring formed by the deformable section, which can ultimately result in an increased squirm pressure, reducing in-plane instability of the compliant heating system.

In comparing the compliant heating systems of FIGS. 5A to 5E, FIGS. 6A to 6D, FIGS. 7A and 7B, and FIGS. 8A to 8C, it is observed that the exhaust gas port of the compliant heating system of FIGS. 7A and 7B, and FIGS. 8A to 8C are directed axially away from the compliant heating system, whereas the exhaust gas port of the compliant heating system of FIGS. 5A to 5E, and FIGS. 6A to 6D are directed laterally away from the compliant heating system. In the compliant heating systems of FIGS. 7A and 7B, and FIGS. 8A to 8C, where the exhaust gas port are directed axially away from the compliant heating system, the differential thermal expansion of the dynamic component acts along the axial axis (as denoted by the dashed line in FIG. 7A) of the fluid heating system and is aligned with the applied strain on the metallic expansion joint. Likewise, although the exhaust gas port of the compliant heating system of FIGS. 6A to 6D is directed laterally away from the compliant heating system, the presence of the U-tube allows for the resultant strain on the metallic expansion joint that arises from the thermal expansion of the dynamic components to be in the same axial direction (e.g., parallel to the axial axis).

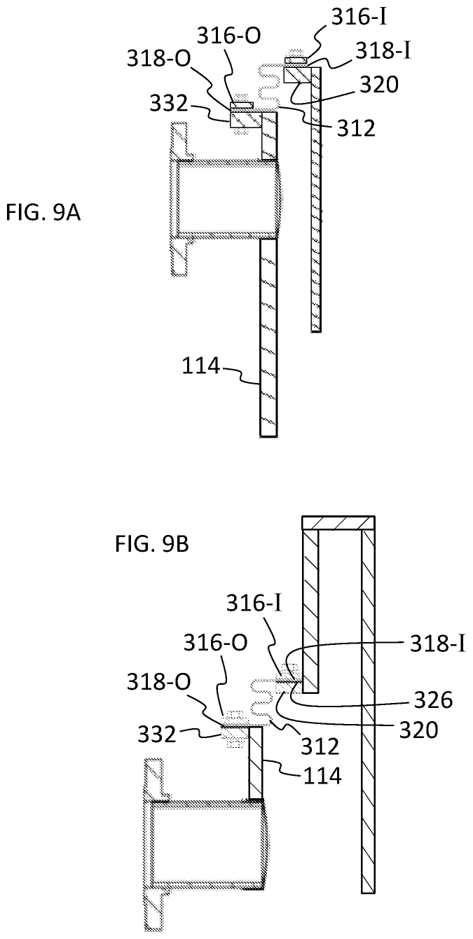

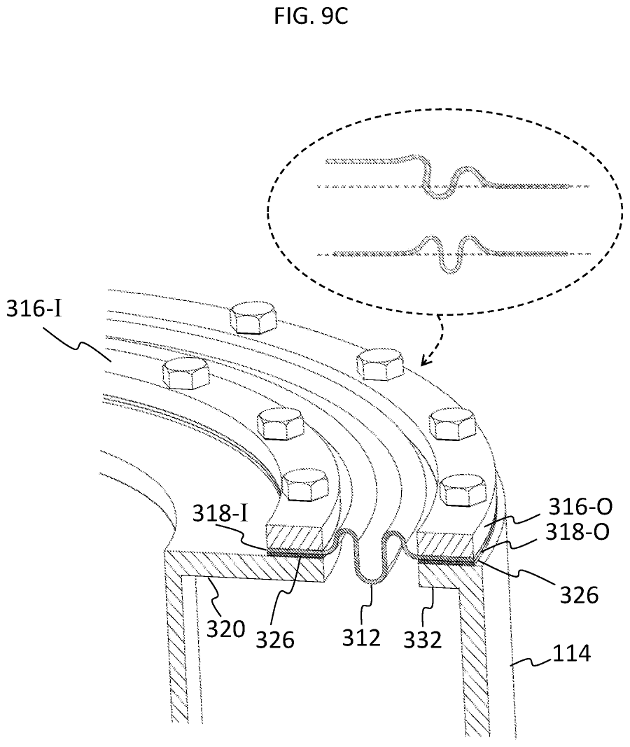

FIGS. 9A to 9C are different embodiments of metallic expansion joints for connecting the pressure vessel shell to a heated component. FIG. 9A and FIG. 9B illustrate that pressure vessel shell 114 can comprise pressure vessel mounting flange 332 and that pressure vessel mounting flange 332 can be connected to heated component flange 320 via the metallic extension joint where the convolutions extend in an axial direction. Pressure vessel mounting flange 332 can be located on the side of the pressure vessel, the top head of the vessel, or the bottom head of the vessel. Heated component flange 320 can be connected to the furnace, the exhaust gas port, or a tube sheet. Pressure vessel mounting flange 332 can be connected to outer mounting ring 316-O via, for example, a screw. Outer metallic extender 318-O can be located in between pressure vessel mounting flange 332 and outer mounting ring 316-O and a gasket can be located in between outer metallic extender 318-O and pressure vessel mounting flange 332. Inner metallic extender 318-I can be connected to heated component flange 320 and inner mounting ring 316-I via, for example, a fastener such as a screw. Gasket 326 can be located between inner metallic extender 318-I and heated component flange 320.

FIG. 9C illustrates that pressure vessel shell 114 can comprise pressure vessel mounting flange 332 and that pressure vessel mounting flange 332 can be connected to heated component flange 320 via a metallic extension joint. Here, deformable section 312 can act as a diaphragm that can deflect in a direction perpendicular to a convolution axis as illustrated by the dotted lines in the inset. Pressure vessel mounting flange 332 can be connected to outer mounting ring 316-O via, for example, a screw. Outer metallic extender 318-O can be located in between pressure vessel mounting flange 332 and outer mounting ring 316-O and a gasket can be located in between outer metallic extender 318-O and pressure vessel mounting flange 332. Inner metallic extender 318-I can be connected to heated component flange 320 and inner mounting ring 316-I via, for example, a screw. Gasket 326 can be located between inner metallic extender 318-I and heated component flange 320. Pressure vessel mounting flange 332 can be located on the top head of the vessel or the bottom head of the vessel. Heated component flange 320 can be connected to the furnace, the exhaust gas port, or a tube sheet.

It is observed that in all of the embodiments of FIGS. 5 to 9 that the metallic expansion joint(s) are externally located on either the pressure vessel shell or on an externally located conduit of the pressure vessel shell. As is noted above, the external location of the metallic expansion joint allows for field servicing without the use of specialized equipment or complex joining techniques such as welding. This facilitated field servicing can result in a regular inspection of the metallic expansion joint for wear, cracking, or fatigue to enable problems to be addressed before component failure. As the metallic expansion joint can be easily inspected, damaged metallic expansion joints can be easily replaced prior to failure, resulting in a longer lifetime of the compliant heating system as compared to non-compliant heating systems.

The various components of the compliant heating system can each independently comprise any suitable material. Use of a metal is specifically mentioned. Representative metals include iron, aluminum, magnesium, titanium, nickel, cobalt, zinc, silver, copper, and an alloy comprising at least one of the foregoing. Representative metals include carbon steel, mild steel, cast iron, wrought iron, a stainless steel such as a 300 series stainless steel or a 400 series stainless steel, e.g., 304, 316, or 439 stainless steel, Monel, Inconel, bronze, and brass. Specifically mentioned is an embodiment in which the heat exchanger core, the pressure vessel, and the deformable section each comprise steel, specifically stainless steel. The compliant heating system may comprise a furnace, an upper tube sheet, a lower tube sheet, and an exhaust gas plenum, and the furnace, the upper tube sheet, the lower tube sheet, and the exhaust gas plenum can each independently comprise any suitable material. Use of a steel, such as mild steel or stainless steel is mentioned. While not wanting to be bound by theory, it is understood that use of stainless steel in the dynamic components can help to keep the components below their respective fatigue limits, potentially eliminating fatigue failure as a failure mechanism.

The disclosed compliant heating system can provide one or more of the following benefits. First, mechanical stress that arises due to the differential thermal expansion of some of the components can be localized to a selected location, e.g., one or more selected locations of the metallic expansion joint. Localization of the mechanical stress to a single component is mentioned. Second, the metallic expansion joint can be located on an external component of the compliant heating system, such as a pressure vessel shell or on a conduit, allowing for easy access for inspection and/or service. Third, in the disclosed configuration, the metallic expansion joint can be inspected and/or serviced without welding or specialized techniques or tooling.

An example of a compliant heating system is a boiler, for example, for the production of hot thermal fluids (such as steam, hot water, non-water based fluids, or a combination comprising one or more of the foregoing). The hot thermal fluids can be used for ambient temperature regulation or water heating. The compliant heating system can be used for domestic, commercial, or industrial applications. In the compliant heating system, the thermally-induced mechanical stress can be localized to replaceable, compliant elements on the exterior pressure vessel to provide improved reliability.

Set forth below are some embodiments of the compliant heating system.

### Embodiment 1

A compliant heating system, comprising: a dynamic component comprising a heat exchanger; a pressure vessel shell encompassing at least a portion of the dynamic component; and a metallic expansion joint that connects the dynamic component and the pressure vessel shell; wherein the metallic expansion joint comprises a deformable section comprising a convolution.

### Embodiment 2

The compliant heating system of Embodiment 1, wherein a thermal expansion of the dynamic component and a thermal expansion of the pressure vessel when the heat exchanger exchanges heat are different.

### Embodiment 3

The compliant heating system of any one of the preceding embodiments, wherein the metallic expansion joint comprises the deformable section, an inner metallic flange fixedly attached to a first end of the deformable section, and an outer metallic flange fixedly attached to a second end of the deformable section; wherein the inner metallic flange is connected to the dynamic component and the outer metallic flange is connected to the pressure vessel shell.

### Embodiment 4

The compliant heating system of any one of Embodiments 1-2, wherein the metallic expansion joint comprises the deformable section, an inner metallic extender extending from a first end of the deformable section, and an outer metallic extender extending from a second end of the deformable section; wherein the inner metallic extender is connected to the dynamic component and the outer metallic extender is connected to the pressure vessel shell.

### Embodiment 5

The compliant heating system of any one of the preceding embodiments, wherein the pressure vessel shell further comprises a pressure vessel shell conduit, and wherein the metallic expansion joint comprises a conduit metallic expansion joint that is located on the pressure vessel shell conduit.

### Embodiment 6

The compliant heating system of Embodiment 5, wherein the pressure vessel shell conduit is disposed along a lateral axis outward from the pressure vessel shell, wherein the dynamic component further comprises an exhaust gas plenum, which is disposed on an end of the heat exchanger, and an exhaust gas port that laterally extends through the pressure vessel shell conduit, and wherein the exhaust gas port is connected to the pressure vessel shell conduit via the conduit metallic expansion joint.

### Embodiment 7

The compliant heating system of Embodiment 6, wherein the convolution has a convolution number of greater than or equal to 3.

### Embodiment 8

The compliant heating system of any one of Embodiments 5-7, wherein the pressure vessel shell conduit comprises a bend in a direction towards an axial direction of the pressure vessel shell, wherein the exhaust gas port comprises the bend in the direction towards the axial direction of the pressure vessel shell, and wherein an annular axis of the conduit metallic expansion joint is parallel to the axial direction of the of the pressure vessel.

### Embodiment 9

The compliant heating system of any one of the foregoing embodiments, wherein the metallic expansion joint comprises a vessel metallic expansion joint that is connected to the pressure vessel shell.

### Embodiment 10

The compliant heating system of Embodiment 9, wherein the vessel metallic expansion joint is connected to one or both of a bottom head and a top head of the pressure vessel shell.

### Embodiment 11

The compliant heating system of any one of Embodiments 9-10, wherein the vessel metallic expansion joint has an annular diameter that is less than a shell diameter of the pressure vessel shell.

### Embodiment 12

The compliant heating system of any one of Embodiments 9-11, further comprising a lower tube sheet which is rigidly connected to the heat exchanger and the pressure vessel shell, and wherein the heat exchanger is in fluid communication with an exhaust gas plenum through the lower tube sheet.

### Embodiment 13

The compliant heating system of any one of Embodiments 10-12, wherein the vessel metallic expansion joint forms a diaphragm on one or both of the top head and the bottom head of the pressure vessel shell.

### Embodiment 14

The compliant heating system of any one of Embodiments 1-5, 8-11, and 13, wherein the dynamic component further comprises an exhaust gas plenum, and wherein the exhaust gas plenum is connected to an exhaust gas port that extends through the pressure vessel shell.

### Embodiment 15

The compliant heating system of any one of the foregoing embodiments, wherein the metallic expansion joint is removable.

### Embodiment 16

The compliant heating system of any one of the foregoing embodiments, wherein the deformable section has a thickness of 0.5 mm to 1 centimeter.

### Embodiment 17

The compliant heating system of any one of the foregoing embodiments, wherein the deformable section has a convolution number of greater than or equal to 0.5.

### Embodiment 18

The compliant heating system of Embodiment 17, wherein the convolution number is 1 to 20.

### Embodiment 19

The compliant heating system of any one of the foregoing embodiments, wherein the metallic expansion joint has a spring constant of 350 N/mm to 35,000 N/mm.

### Embodiment 20

The compliant heating system of any one of the foregoing embodiments, wherein the metallic expansion joint has a squirm pressure of 100 to 1,380 kPa.

### Embodiment 21

The compliant heating system of any one of the foregoing embodiments, wherein the heat exchanger comprises a plurality of heat exchanger tubes.

### Embodiment 22

A method of manufacturing the compliant heating system of any one of the foregoing embodiments, the method comprising: disposing the dynamic component in the pressure vessel shell; connecting the dynamic component and the pressure vessel shell with a rigid attachment located proximal to a first end of the compliant heating system; and connecting the dynamic component and the pressure vessel shell with the metallic expansion joint located proximal to a second end of the compliant heating system to manufacture the compliant heating system.

### Embodiment 23

A method of using the compliant heating system of any one of the foregoing embodiments, the method comprising: directing a heating fluid through the heat exchanger to an exhaust gas port; and transferring heat from the heating fluid to a production fluid located in an inner production fluid area.

### Embodiment 24

A method of servicing the compliant heating system of any one of the foregoing embodiments, the method comprising: replacing the metallic expansion joint with a new metallic expansion joint.

The disclosed system can alternately comprise, consist of, or consist essentially of, any appropriate components herein disclosed. The disclosed system can additionally be substantially free of any components or materials used in the prior art that are not necessary to the achievement of the function and/or objectives of the present disclosure.

The terms “a” and “an” do not denote a limitation of quantity, but rather denote the presence of at least one of the referenced item. The term “or” means “and/or” unless clearly indicated otherwise by context. Reference throughout the specification to “an embodiment”, “another embodiment”, “some embodiments”, and so forth, means that a particular element (e.g., feature, structure, step, or characteristic) described in connection with the embodiment is included in at least one embodiment described herein, and may or may not be present in other embodiments. In addition, it is to be understood that the described elements may be combined in any suitable manner in the various embodiments. “Optional” or “optionally” means that the subsequently described event or circumstance may or may not occur, and that the description includes instances where the event occurs and instances where it does not. The terms “first,” “second,” and the like, “primary,” “secondary,” and the like, as used herein do not denote any order, quantity, or importance, but rather are used to distinguish one element from another. The terms “front”, “back”, “bottom”, and/or “top” are used herein, unless otherwise noted, merely for convenience of description, and are not limited to any one position or spatial orientation.

The endpoints of all ranges directed to the same component or property are inclusive of the endpoints, are independently combinable, and include all intermediate points. For example, ranges of “up to 25 N/m, or more specifically 5 to 20 N/m” are inclusive of the endpoints and all intermediate values of the ranges of “5 to 25 N/m,” such as 10 to 23 N/m.

Unless defined otherwise, technical and scientific terms used herein have the same meaning as is commonly understood by one of skill in the art to which this invention belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

What is claimed is:

1. A compliant heating system, comprising:
a dynamic component comprising a heat exchanger;
a pressure vessel shell encompassing at least a portion of the dynamic component; and
a metallic expansion joint that connects the dynamic component and the pressure vessel shell,
wherein the metallic expansion joint comprises a deformable section comprising a convolution.

2. The compliant heating system of claim 1, wherein a thermal expansion of the dynamic component and a thermal expansion of the pressure vessel, when the heat exchanger exchanges heat, are different.

3. The compliant heating system of claim 1, wherein the metallic expansion joint comprises the deformable section, an inner metallic flange fixedly attached to a first end of the deformable section, and an outer metallic flange fixedly attached to a second end of the deformable section,
wherein the inner metallic flange is connected to the dynamic component and the outer metallic flange is connected to the pressure vessel shell.

4. The compliant heating system of claim 1, wherein the metallic expansion joint comprises the deformable section, an inner metallic extender extending from a first end of the deformable section, and an outer metallic extender extending from a second end of the deformable section,
wherein the inner metallic extender is connected to the dynamic component and the outer metallic extender is connected to the pressure vessel shell.

5. The compliant heating system of claim 1,
wherein the pressure vessel shell further comprises a pressure vessel shell conduit, and
wherein the metallic expansion joint comprises a conduit metallic expansion joint that is located on the pressure vessel shell conduit.

6. The compliant heating system of claim 5,
wherein the pressure vessel shell conduit is disposed along a lateral axis outward from the pressure vessel shell,
wherein the dynamic component further comprises
an exhaust gas plenum, which is disposed on an end of the heat exchanger, and
an exhaust gas port that laterally extends through the pressure vessel shell conduit, and
wherein the exhaust gas port is connected to the pressure vessel shell conduit via the conduit metallic expansion joint.

7. The compliant heating system of claim 6, wherein the convolution has a convolution number of greater than or equal to 3.

8. The compliant heating system of claim 5,
wherein the pressure vessel shell conduit comprises a bend in a direction towards an axial direction of the pressure vessel shell,
wherein the exhaust gas port comprises the bend in the direction towards the axial direction of the pressure vessel shell, and
wherein an annular axis of the conduit metallic expansion joint is parallel to the axial direction of the of the pressure vessel.

9. The compliant heating system of claim 1, wherein the metallic expansion joint comprises a vessel metallic expansion joint that is connected to the pressure vessel shell.

10. The compliant heating system of claim 9, wherein the vessel metallic expansion joint is connected to one or both of a bottom head and a top head of the pressure vessel shell.

11. The compliant heating system of claim 9, wherein the vessel metallic expansion joint has an annular diameter that is less than a shell diameter of the pressure vessel shell.

12. The compliant heating system of any one of claim 9,
further comprising a lower tube sheet which is rigidly connected to the heat exchanger and the pressure vessel shell, and
wherein the heat exchanger is in fluid communication with an exhaust gas plenum through the lower tube sheet.

13. The compliant heating system of claim 10, wherein the vessel metallic expansion joint forms a diaphragm on one or both of the top head and the bottom head of the pressure vessel shell.

14. The compliant heating system of claim 1,
wherein the dynamic component further comprises an exhaust gas plenum, and
wherein the exhaust gas plenum is connected to an exhaust gas port that extends through the pressure vessel shell.

15. The compliant heating system of claim 1, wherein the metallic expansion joint is removable.

16. The compliant heating system of claim 1, wherein the deformable section has a thickness of 0.2 mm to 10 centimeters.

17. The compliant heating system of claim 1, wherein the deformable section has a convolution number of greater than or equal to 0.5.

18. The compliant heating system of claim 17, wherein the convolution number is 1 to 20.

19. The compliant heating system claim 1, wherein the metallic expansion joint has a spring constant of 175 to 44,000 N/mm, or 350 to 35,000 N/mm, or 450 to 27,000 N/mm.

20. The compliant heating system of claim 1, wherein the metallic expansion joint has a squirm pressure 35 to 1,750 kPa, 70 to 1,380 kPa, or 100 to 1,200 kPa.

21. (canceled)

22. (canceled)

23. (canceled)

24. (canceled)
